(19) United States
(12) Patent Application Publication
(10) Pub. No.: US 2017/0283074 A1
(43) Pub. Date: Oct. 5, 2017

(54) AIRCRAFT AIR CONDITIONING SYSTEM INCLUDING A THERMOELECTRIC DEVICE

(71) Applicant: HAMILTON SUNDSTRAND CORPORATION, Windsor Locks, CT (US)

(72) Inventors: Thomas M. Zywiak, Southwick, MA (US); Brian St. Rock, Andover, CT (US)

(21) Appl. No.: 15/087,347

(22) Filed: Mar. 31, 2016

(51) Int. Cl. B64D 13/08; B64D 13/02; F25B 21/02; F25B 43/00; F25B 9/00; F25B 9/06

(52) U.S. Cl. CPC B64D 13/08; F25B 9/004; F25B 9/06; F25B 21/02; F25B 43/00; B64D 13/02; F25B 2321/0251; B64D 2013/0618

(57) ABSTRACT

A environmental control system (ECS) for an aircraft includes a primary heat exchanger configured to receive bleed air from a turbine compressor of the aircraft and a secondary heat exchanger having an input configured to receive a flow from the primary heat exchanger and a secondary heat exchanger output. The ECS also includes a thermoelectric condensing device having an input in fluid communication with the output of the secondary heat exchanger and also having a thermoelectric condensing device output.

### BACKGROUND OF THE INVENTION

The present disclosure relates to an air conditioning system for an aircraft and, in particular, to using a thermoelectric device to regulate the air used to regulate temperature in an aircraft.

Conventional aircraft environmental control systems (ECSs) incorporate an air cycle machine, also referred to as an air cycle cooling machine, for use in cooling and dehumidifying air for an aircraft cabin. The air cycle machine may receive bleed air from a compressor that may have been passed through a primary heat exchanger (PEX).

In more detail, on aircraft powered by turbine engines, the air to be conditioned in the air cycle machine is typically air bled from one or more of compressor stages of the turbine engine. In conventional systems, this bleed air passes through the air cycle machine compressor where it is further compressed. The compressed air is passed through a heat exchanger (condenser) to cool the compressed air sufficiently to remove moisture and dehumidify the air. The dehumidified compressed air is expanded in a first turbine of the air cycle machine to both extract energy from the compressed air so as to drive the shaft and also to cool the expanded turbine exhaust air before it is supplied to the aircraft cabin as conditioned cooling air. The cooled expanded air serves as the cooling cross-flow in the condenser and is then may be further expanded in a second turbine before being provided to aircraft cabin.

### SUMMARY OF THE INVENTION

According to one embodiment, an environmental control system (ECS) for an aircraft is disclosed. The ECS includes a primary heat exchanger configured to receive bleed air from a turbine compressor of the aircraft and a secondary heat exchanger having an input configured to receive a flow from the primary heat exchanger and a secondary heat exchanger output. The ECS further includes a thermoelectric condensing device having an input in fluid communication with the output of the secondary heat exchanger and also having a thermoelectric condensing device output.

Also disclosed is an aircraft that includes an aircraft cabin and turbine that includes a turbine compressor and an environmental control system (ECS). The ECS includes: a primary heat exchanger that receives bleed air from the compressor of the aircraft, a secondary heat exchanger having an input configured to receive a flow from the primary heat exchanger and a secondary heat exchanger output; and a thermoelectric condensing device having an input in fluid communication with the output of the secondary heat exchanger and also having a thermoelectric condensing device output.

In another embodiment, a environmental control system (ECS) for an aircraft is disclosed. The ECS of this embodiment includes an air cycle machine that includes a turbine and a compressor and a thermoelectric condensing device that is in fluid communication with an output of the compressor and an input of the turbine.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 shows a high level block diagram an environmental control system (ECS) that includes an air cycle machine (ACM) according to the prior art.

FIG. 2 shows an example of an ECS that includes a thermoelectric condensing device that may be utilized in one embodiment; and

FIG. 3 shows another example of an ECS that includes a thermoelectric condensing device that may be utilized in one embodiment.

### DETAILED DESCRIPTION OF THE INVENTION

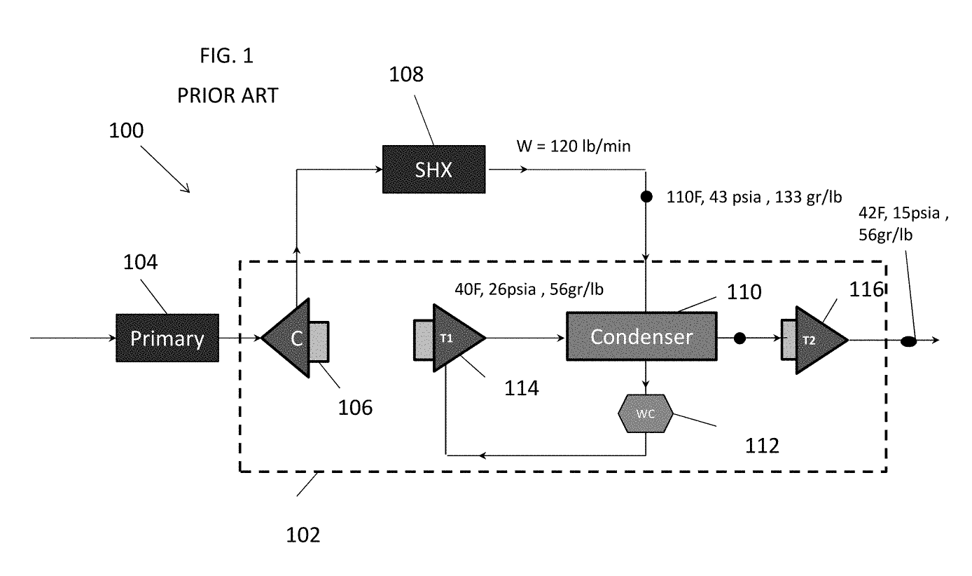

FIG. 1 shows a high level block diagram an ECS 100 that includes an air cycle ACM 102 according to the prior art. Hot air from a compressor is received at a primary heat exchanger (PHX) 104. The air is cooled in the PHX 104 by cross-flow from a ram air fan in some cases. After being cooled the air is provided to the ACM 102 and compressed by compressor 106. For example, on a hot day at sea level the compressor 106 causes the air pressure to be increased which, in turn, heats the air. The heated air enters a secondary heat exchanger (SHX) 108. Again, the SHX may cool the air my providing a flow across the input flow from a ram air fan. In the following, the input flow will refer to air that has passed through the PHX and the compressor 106. The cooled air is then passed through a condenser 110 that causes water vapor in the input flow to condense into water droplets and be removed through a separator 112. The water extracted by the separator 112 may be simply dumped overboard or may be sprayed into the ram-air intakes where the PHX 104 and SHX 108 are located to improve their cooling efficiency.

A first turbine 114 receives the de-humidified air and allows it to expand. The expansion both further cools the air and provides for rotation of the shaft (not shown) to which the compressor 106, the first turbine 114 and the second turbine 116 are all attached. The cooled air then is crossflowed back across the condenser 110 and to provide for cooling the condenser 110. Finally, the air may be further expanded in the second turbine 116 and then provided into the cabin. In FIG. 1, various example parameters of the input flow at various stages are shown by way of example. These values are not limiting but are examples and are incorporated into this specification as is set forth explicitly herein.

Embodiments herein allow for the removal of at least the first turbine 114 and the condenser 110. This may be accomplished by providing a thermoelectric condenser downstream of the SHX 108. The condenser includes a thermoelectric (TE) device. In one embodiment, the TE device is superlattice device. The TE device, when powered, “pumps” heat from the input flow to a location where the heat may be removed by, for example, a ram air flow and provides that heat to the ram air.

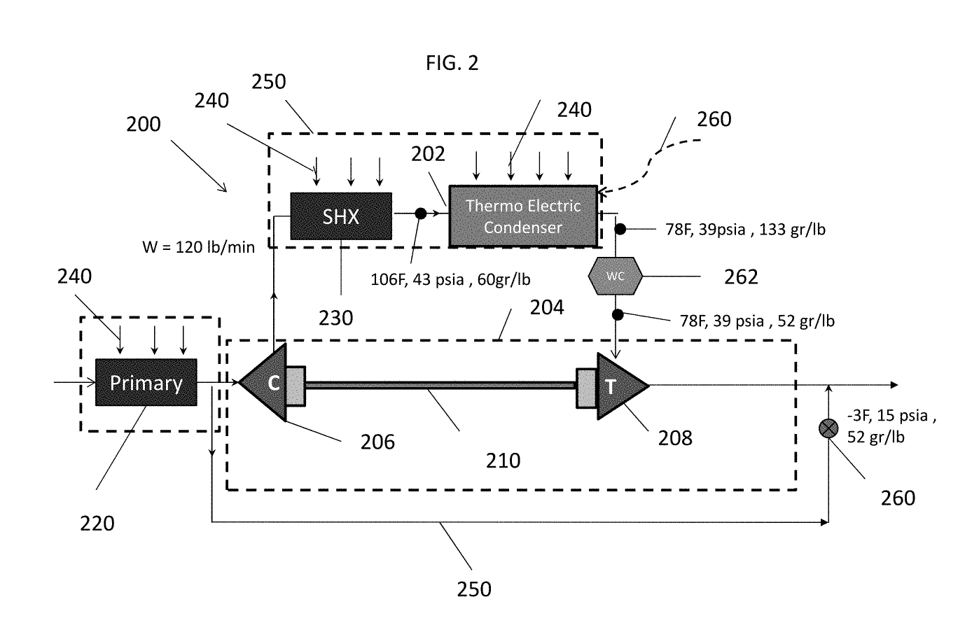

FIG. 2 shows an example of an ECS 200 that includes a thermoelectric condensing device (TECD) 202 that may be utilized in one embodiment. In FIG. 2, various example parameters of the input flow at various stages are shown by way of example. These values are not limiting but are examples and are incorporated into this specification as is set forth explicitly herein.

The ECS 200 includes an ACM 204. In this embodiment, the ACM 204 includes a compressor 206 and a turbine 208 connected to co-resident on a shaft 210. It shall be understood that expansion of a flow in the turbine 208 may provide rotational energy to drive the compressor 206 in one embodiment.

An incoming flow from a turbine (e.g., jet engine) may be passed through a PHX 220. Ram air (shown by arrows 240) may cool the received flow in a known manner. That same ram air may also be used to cool flows received by the SHX 230 and the TECD 202. As such, all are shown as being included in ram air channel as generally indicated by dashed boxes 250. It shall be understood that the exact orientation and arrangement of the PHX 220, the SHX 230 and the TECD 202 may be varied from that shown in FIG. 2. For instance, the SHX 230 and the TECD 202 could be in series or parallel and the PHX could be in front or behind either or both the SHX 230 and the TECD 202.

The air leaving the PHX 240 is compressed by compressor 206 and provided to the SHX where it is cooled. That air is then further cooled by the TECD 202. The heat is pumped from the flow where it is carried away by the ram air 240 due to application electrical power 260 to the TECD 202. Removal of the heat by the TECD 202 may cause the vapor in the flow to become liquid water droplets. The liquid water droplets are removed from the flow by cyclone 262. The dehumidified flow may then be expanded in turbine 208 of the ACM 204. If need, a bypass line 250 may be provided between the output of the PHX 240 to control the temperature of the flow before it is provided to the cabin and that bypass line 250 is controlled by a valve 260.

From time to time herein, an element may be described as being located in a fluid path between two elements. For example, the water cyclone 262 is fluid communication with the TECD 202 and the turbine 208 and is disposed in a fluid path between them.

In this version, the ram cooled TECD may allow for the omission of the first turbine 114 of FIG. 1. In addition, it may allow for the reduction of the ACM 240 outlet temperature to drop by up to 60%. In the illustrated example, the TECD 202 may cool the air at 2250 BTU/min (39 kW).

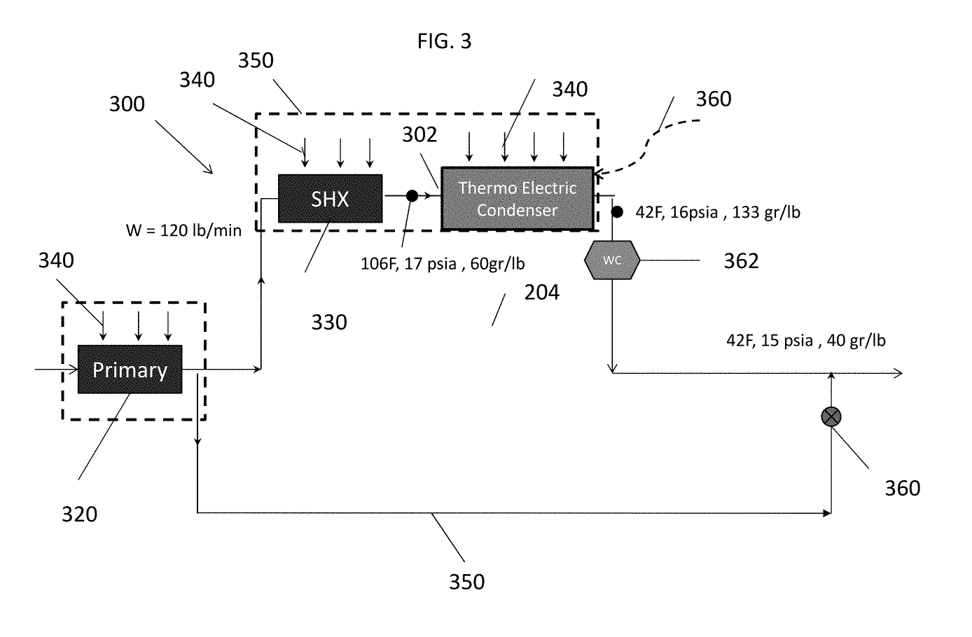

According to another embodiment, the ACM 204 may be eliminated in whole or in part. For instance, in FIG. 3, the ECS 300 includes a thermoelectric condensing device (TECD) 302 that may be utilized in one embodiment. In FIG. 3, various example parameters of the input flow at various stages are shown by way of example. These values are not limiting but are examples and are incorporated into this specification as is set forth explicitly herein.

An incoming flow from a compressor (e.g., jet engine) may be passed through a PHX 320. Ram air (shown by arrows 340) may cool the received flow in a known manner. That same ram air may also be used to cool flows received by the SHX 330 and the TECD 302. As such, all are shown as being included in ram air channel as generally indicated by dashed boxes 350. It shall be understood that the exact orientation and arrangement of the PHX 320, the SHX 330 and the TECD 302 may be varied from that shown in FIG. 3. For instance, the SHX 330 and the TECD 302 could be in series or parallel and the PHX could be in front or behind either or both the SHX 330 and the TECD 302.

The air leaving the PHX 340 provided to the SHX where it is cooled. That air is then further cooled by the TECD 302. The heat is pumped from the flow where it is carried away by the ram air 340 due to application electrical power 360 to the TECD 202. Removal of the heat by the TECD 202 may cause the vapor in the flow to become droplets. The mist is removed from the flow by cyclone 362. If need, a bypass line 350 may be provided between the output of the PHX 240 to control the temperature of the flow before it is provided to the cabin and that bypass line 350 is controlled by a valve 360.

In this version, the ram cooled TECD may allow for the omission of the first and second turbines 114, 116 of FIG. 1. In addition, in some instances, the compressor may also be omitted leading to an ECS that does not include an ACM. In the illustrated example, the TECD 302 may cool the air at 3530 BTU/min (62.2 kW).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention.

Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A environmental control system (ECS) for an aircraft, the ECS including:
a primary heat exchanger configured to receive bleed air from a turbine compressor of the aircraft;
a secondary heat exchanger having an input configured to receive a flow from the primary heat exchanger and a secondary heat exchanger output; and
a thermoelectric condensing device having an input in fluid communication with the output of the secondary heat exchanger and also having a thermoelectric condensing device output.

2. The ECS of claim 1, further comprising:
a water cyclone in fluid communication with the thermoelectric condensing device outlet.

3. The ECS of claim 1, wherein at least one of the primary heat exchanger, the secondary heat exchanger and the thermoelectric condensing device are disposed in a ram air channel of the aircraft.

4. The ECS of claim 1, wherein the primary heat exchanger, the secondary heat exchanger and the thermoelectric condensing device are disposed in a ram air channel of the aircraft.

5. The ECS of claim 1, further comprising:
an air cycle machine that includes a turbine and a compressor.

6. The ECS of claim 5, wherein the compressor includes a compressor input in fluid communication with the primary heat exchanger and an output in fluid communication with the input of the secondary heat exchanger such that the flow passes through the compressor after it leaves the primary heat exchanger and before it enters the secondary heat exchanger.

7. The ECS of claim 5, wherein the turbine has input in fluid communication with the thermoelectric condensing device output.

8. An aircraft comprising:
an aircraft cabin;
a turbine compressor; and
an environmental control system (ECS), the ECS including:
a primary heat exchanger that receives bleed air from the turbine compressor;
a secondary heat exchanger having an input configured to receive a flow from the primary heat exchanger and a secondary heat exchanger output; and
a thermoelectric condensing device having an input in fluid communication with the output of the secondary heat exchanger and also having a thermoelectric condensing device output.

9. The aircraft of claim 8, wherein the ECS further includes:
a water cyclone in fluid communication with the thermoelectric condensing device outlet.

10. The aircraft of claim 8, wherein at least one of the primary heat exchanger, the secondary heat exchanger and the thermoelectric condensing device are disposed in a ram air channel of the aircraft.

11. The aircraft of claim 8, wherein the ECS further includes:
an air cycle machine that includes a turbine and a compressor.

12. The aircraft of claim 11, wherein the compressor includes a compressor input in fluid communication with the primary heat exchanger and an output in fluid communication with the input of the secondary heat exchanger such that the flow passes through the compressor after it leaves the primary heat exchanger and before it enters the secondary heat exchanger.

13. The aircraft of claim 11, wherein the turbine has input in fluid communication with the thermoelectric condensing device output.

14. A environmental control system (ECS) for an aircraft, the ECS including:
an air cycle machine that includes a turbine and a compressor; and
a thermoelectric condensing device that is in fluid communication with an output of the compressor and an input of the turbine.

15. The ECS of claim 14, further comprising:
a water cyclone in fluid communication with the thermoelectric condensing device and the turbine and disposed in a fluid path between them.
